(19) United States
(12) Patent Application Publication
(10) Pub. No.: US 2008/0037446 A1
(43) Pub. Date: Feb. 14, 2008

(54) FACILITATING CONNECTION TO A CONFERENCE CALL

(75) Inventors: XIAOHUI ZHOU, CARY, NC (US); GLENN INN, SAN MATEO, CA (US); KANG YUAN, SAN JOSE, CA (US)

Correspondence Address: MARGER JOHNSON & MCCOLLOM, P.C., 210 SW MORRISON STREET, SUITE 400, PORTLAND, OR, 97204, US

(73) Assignee: CISCO TECHNOLOGY, INC., SAN JOSE, CA (US)

(21) Appl. No.: 11/463,257

(22) Filed: Aug. 8, 2006

(51) Int. Cl. H04L 12/16; H04Q 11/00

(52) U.S. Cl. 370/260

(57) ABSTRACT

In one embodiment, a user can send a message to all available, scheduled participants in a conference call by pressing a conference notification softkey. When this conference notification softkey is pressed, a message concerning the conference call appears on the display screen of the available scheduled participants. The available scheduled participants can connect to the conference call by pressing a conference connect softkey on their telephone set

### FIELD OF THE INVENTION

The present invention relates to the communications systems, including wired and wireless telephone systems and more particularly to conference calls on such systems.

### BACKGROUND

Conference calls connect several telephone users into a single conversation. Conference calls are widely used for both business and personal reasons.

There are a variety of devices that are commercially available to facilitate the implementation of conference calls. Such devices are available in Plain Old Telephone Systems (POTS systems), in Voice Over IP telephone systems (VoIP systems), and in cellular telephone systems, etc.

In VoIP telephone systems, conference calls are usually established using a conference bridge server (sometimes referred to as a conference call server or by various other names) that communicates with the Internet Protocol softswitch that interconnects calls. A wide variety of bridge servers are commercially available.

In many systems a user establishes a connection to a conference call by dialing a specified number and then entering a code number. In some situations a human operator is involved and in many systems the process is partially or completely automated. In one type of conference call, all participants can hear and speak during the conference call. In other type of conference call some of the participants can only hear the dialog and they can not speak on the conference call.

### BRIEF DESCRIPTION OF THE FIGURES

FIG. 1 illustrates an example system facilitating connection to a conference call.

FIG. 2 illustrates an example endpoint.

FIG. 3 illustrates and example IP-PBX in the system illustrated in FIG. 1.

FIG. 4 illustrates an example program flow facilitating connection to a conference call.

### DETAILED DESCRIPTION OF EXAMPLE EMBODIMENTS

Several preferred embodiments of the present invention are described below with reference to the accompanying drawings. Various other embodiments of the invention are also possible and practical. Thus, this invention may be embodied in many different forms and the invention should not be construed as being limited to the embodiments set forth herein.

The figures listed above illustrate a preferred embodiment of the invention and the operation of such embodiment. In the figures, the size of the boxes is not intended to represent the size of the various physical components. Where the same element appears in multiple figures, the same reference numeral is used to denote the element in all of the figures where it appears.

Only those parts of the various units are shown and described which are necessary to convey an understanding of the embodiment to those skilled in the art. Those parts and elements not shown are conventional and known in the art.

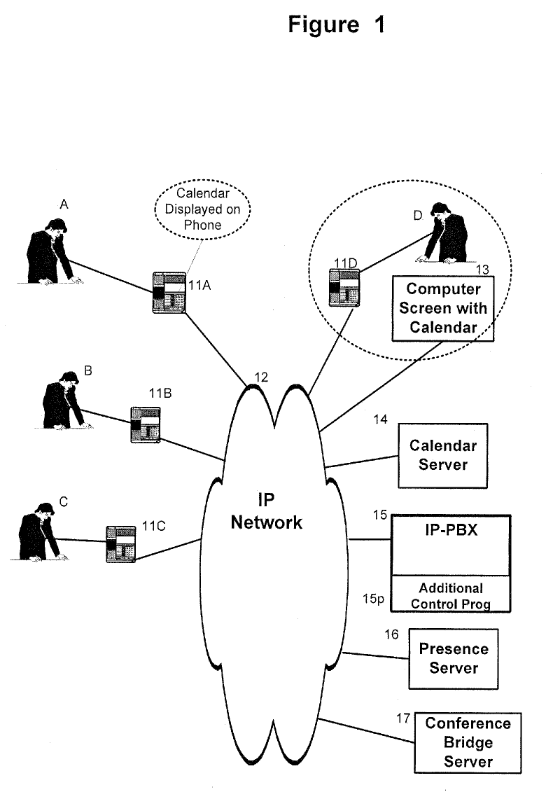

FIG. 1 shows Voice over Internet Protocol (VoIP) telephone system with four users that are designated A, B, C and D. It is noted that only four users are shown for convenience of illustration and description; however, it should be understood that the VoIP system shown may have any number of users up to the capacity of the various units in the system.

In the embodiment described herein, the system facilitates setting up a conference call between the users A, B, C and D. As will be described in detail below, user D can notify all participants that a conference call is available by merely pressing a “Conference Notification” softkey. Each of the users can connect to the conference call by merely pressing a “Conference Connect” softkey.

First, the overall system and the various units in the system will be described. After the various units in the system have been described, the manner in which the system operates to notify participants that a conference call is ready and how participants connect to the conference call will be described. Various alternative embodiments will also be described.

Each of the users A, B C and D has a telephone line and an endpoint device, respectively 11A, 11B, 11C and 11D. In the specific embodiment shown and described herein the endpoint devices 11A, 11B, 11C and 11D are telephone sets. The term telephone set is used herein to denote the combination of a base unit or desk set and a telephone handset that the user can pick up and hold. However, as explained below, other embodiments of the inventions utilize other types of telephone devices and other types of endpoint devices.

The telephone sets 11A, 11B, 11C and 11D are connected to the IP network 12 in a conventional manner. Such a connection can include a conventional cable modem at the user's premises and a coaxial cable connected to a cable
modem termination system that is located at a central station. The IP network 12 can be a private wide area packet network or alternately IP network 12 can be the public Internet.

The system includes an IP-PBX softswitch 15 that is connected to IP network 12. Telephone sets 11A to 11D are connected to each other and to other telephone sets (not shown in the diagram) by the IP-PBX softswitch 15 in a conventional manner.

The system also includes a presence server 16, a bridge server 17, and a calendar server 14. The presence server 16, the conference bridge server 17, and the calendar server 14 are conventional units or programs that are connected to the IP network 12 and they are controlled by the IP-PBX 15 in a conventional manner.

The presence server 16 can determine which users are available and it can send instant messages to the screens of their telephone sets. The calendar server 14 includes a calendar program that provides conference call scheduling information. The information from calendar server 14 indicates when a conference call is scheduled and it also provides the names of the scheduled participants in a scheduled conference call. The conference bridge server 17 is the unit that actually handles the interconnection of the participants in a conference call. The presence server 16, the calendar server 14 and the conference bridge server 17 are conventional units.

User D has a conventional personal computer 13 with a screen that displays calendar information from calendar server 14. The display of calendar information is conventional. The display available to user D indicates if a conference call is scheduled. That is, calendar server 14, causes a calendar to be displayed on the computer screen 13 showing user D the scheduled time for a conference call. User D can thus see that the time for a conference call has arrived. As described below, when the time for a conference call has arrived, user D will notify the other participants that the time for the call has arrived.

User D can notify the other participants that the time for a conference call has arrived by highlighting the meeting notice and either, clicking on an appropriate box displayed by the calendar program or by pressing a Conference Notification softkey that appears on user D's telephone set. When either of the above actions occurs, a notification will be sent by presence server 16 to the screen of the telephone sets of the other participants. The notification is sent by presence server 16 in the form of a conventional instant message (IM).

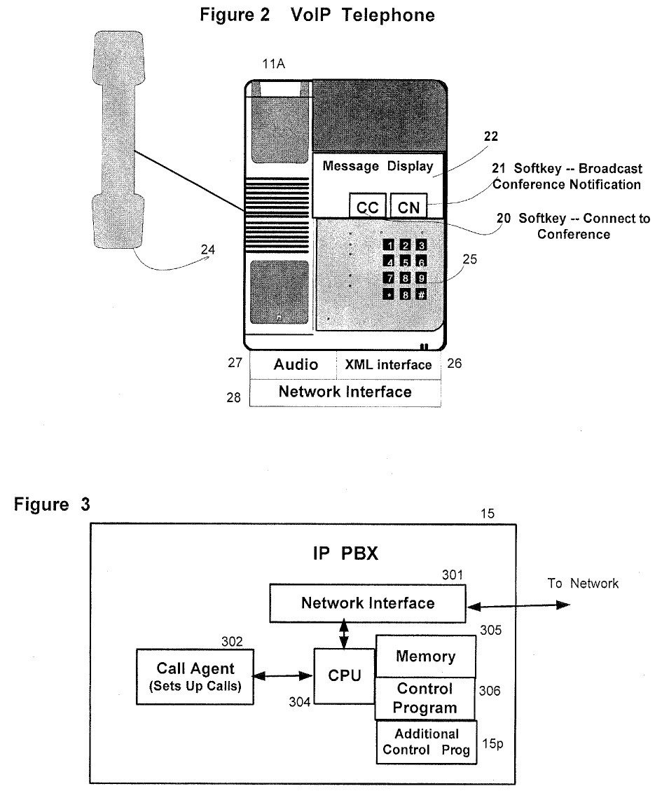

FIG. 2 is a diagram of telephone set 11A showing additional detail of the telephone set. Each of the other telephone sets 11B, 11C and 11D are similar to telephone set 11A that is shown in FIG. 2. The telephone set 11A has a screen 22 that can display instant messages, a keyboard 25 to enter numbers and a hand piece 24. The telephone set includes a conventional network interface 28. The network interface 28 provides and receives IP packets to and from a conventional audio interface 27 and a conventional Instant messaging (XML) interface 26.

The telephone set 11A can have a variety of conventional softkeys; however, only two softkeys 20 and 21 are shown in FIG. 2 and discussed herein since these are the only softkeys that are relevant to the conference call system being described herein. When a user, such as user D, notices that the calendar program indicates that the time for a scheduled conference call has arrived, user D will highlight the conference call entry on the calendar display and press the Conference Notification softkey 21 which is designated CN in the FIG. 2. It is noted that in an alternative embodiment the Conference Notify operation is initiated by clicking on or entering data in the calendar program display.

When the Conference Notification softkey CN is pressed, the telephone set will send a command to the presence server 16 that will generate commands to cause the following to occur.
1) The calendar program will be interrogated to determine who is scheduled to participate in the conference call.
2) The presence server 16 will determine which of the scheduled participants are available, and
3) Instant Messages (IM's) will be sent to the display screens of the available participants notifying them that they are scheduled to participate in a conference call.

When a user sees a notice on his display indicating that the time for participation in a conference call has occurred, the user can press the Conference Connect (CC) softkey 20. When softkey 20 is pressed the IP-PBX will generate commands to immediately connect the user to the conference call.

FIG. 3 is a block diagram showing the relevant parts of the IP-PBX 15. The IP-PBX 15 includes a network interface 301 and a call agent 302 that sets up VoIP calls. The network interface 301 and the call agent 302 are conventional. The IP-PBX 15 also includes a CPU 304, memory 306, and control programs 306 and 15p. The CPU 304 controls the actions of IP-PBX 15 in response to the control programs 306 and 15p. The control program 306 controls the conventional operations of the IP-PBX. The additional control programming 15p controls the special functions described herein relative to conference calling.

A wide variety of IP PBX softswitches, presence servers, conference bridge servers and calendar servers are commercially available. Many of the commercially available softswitches include the ability to control associated servers such as calendar server 14, presence server 16 and conference bridge server 17. IP-PBX softswitch 15 can, for example, be a softswitch such as that marketed by Cisco Systems Inc. and designated “Cisco Unified Callmanager”.

There are many different presence servers that are commercially available. The presence server 16 can for example be the presence server marketed by Cisco Systems Inc. and designated the “Cisco Unified Presence Server 1.0”. Likewise, there are wide varieties of conference bridge servers and calendar servers that are commercially available. Many such servers are programs that run on general purpose servers such as the servers commercially marketed by Microsoft Corporation. Conference bridge server 17 can, for example, be the bridge program marketed by Cisco Systems inc. under the designation “Cisco Unity Bridge 3.0”. The Calendar server 14 can for example be the Sun Java System Calendar Server that is part of the Solaris Enterprise System marketed by Sun Microsystems Inc.

It is noted that the specific products listed above are merely examples. A wide variety of such products are commercially available. Furthermore, while in the embodiment illustrated a separate box is shown for each unit, a plurality of the units can be implements as programs running on a single hardware server.

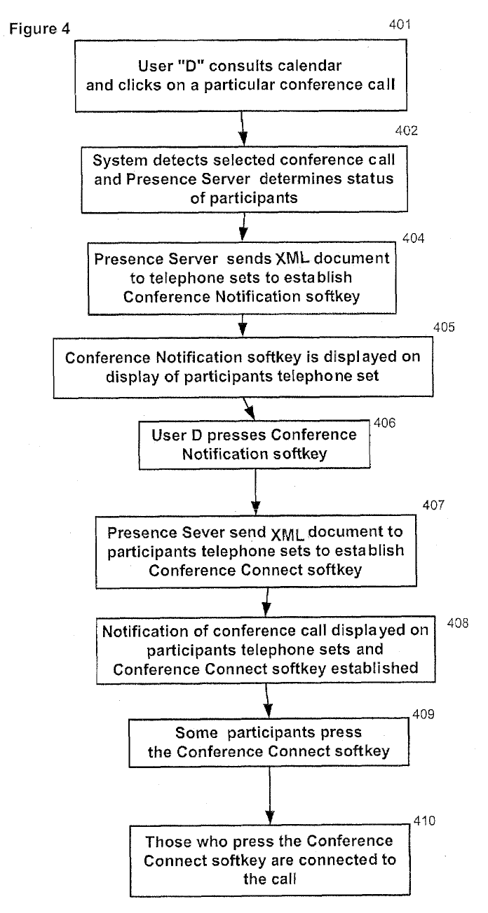

FIG. 4 is a flow diagram explaining the operation of the system shown in FIGS. 1, 2 and 3. The steps illustrated in FIG. 4 show how a user (such as user D) notifies the other scheduled participants in a conference call that the time has arrived for the call. FIG. 4 also illustrates how the other participants to the conference call easily connect to the call by merely pressing a softkey on their telephone sets.

The process begins as illustrated by block 401 when user D consults the calendar on screen 13 and notices that the scheduled time has arrived to begin a conference call. User D highlights the conference call on the calendar program. When the particular conference call has been highlighted, the IP-PBX 15 is notified and IP-PBX 15 determines from the presence server 16, which of the participants are available as indicated by block 402.

As indicated by block 404, the Presence Server 16 sends an XML document to the telephone set of user D. This XML documents causes a message ito be displayed on the screen of user D telephone set indicating which are the participants is available. The XML document also sets up the CN softkey. The softkey is set up in a conventional manner. The XML document is sent as an IM from presence server 16 to telephone set 11D. In the particular embodiment described herein, the IM between the telephone set and the presence sever 16 uses a standard Cisco VoIP telephone XML service. The softkey definitions are embedded in the XML document.

When user D presses the CN softkey, as indicated by block 406, an XML document is sent to the telephone set of each of the available participants by presence server 16 as indicated by block 407. The message notifies the other participants that the time for the conference call has arrived and it sets up the Conference Connect softkey as indicated by block 408.

As indicated by block 409, the various participants can decide to press the Conference connect softkey and be connected to the conference call.

When a scheduled participant that has been notified that the time for a call has arrived pressed the Conference Connect softkey, the user is immediately connected to the conference call.

In summary, the conference coordinator who views the details of a scheduled conference call on a calendar program can press a single softkey and thereby broadcast a text message to each of the other available scheduled participants, notifying them that the time for a conference call has arrived. The recipients of the text message can connect to the conference call by pressing a single softkey on their telephone sets.

It is noted that a wide variety of other embodiments are possible without departing from the sprit and scope of the invention. For example, the calendar program can display information about a scheduled conference call on the screen 22 of the conference call coordinator rather than on a separate computer screen 13. This is illustrated in FIG. 1 by the dotted circle near telephone set 11A in FIG. 1.

In another embodiment, the CC softkey can also or alternatively be used for the purpose of directly establishing and connecting to a single party with whom a telephone call has been scheduled. For example, if a calendar program indicates to user D that the time has arrived for a scheduled telephone call to user A, User D would highlight the entry on the calendar program and press the CC softkey. This would establish a telephone call to user A.

In an alternate embodiment, the conference coordinator needs not press the conference notify key to notify the participants that the time for a conference call has arrived. Instead, when the time for a conference call arrives, the presence server automatically sends an instant message to each of the scheduled participants that the time for the call has arrived.

In still another embodiment, instead of sending instant text messages concerning a conference call to the scheduled participants, a dial-out is placed to each of the scheduled but missing participants. If the person answers, an invitation message is played. If there is not answer, then a voice message is left for each of the scheduled, missing and non-answering participants.

It is noted that the term softkey as used herein means any type of device, the activation of which can be detected. Thus, the term softkey means any conventional key displayed on a touch screen, or any hard key that has the described function, or any type of mechanical switch the activation of which can be detected.

In the specific embodiments described herein, each telephone line is connected to a telephone handset. If the telephone handsets are VoIP telephones, the lines are merely communication paths that carry packets of information. The term “line” is used to mean a communication path as is conventional in the art. Thus the term “line” can mean a communication path or it can mean a hard wired connection as is a POTS telephone system. It is noted that telephone handsets are merely one type of endpoint device. Various other types of endpoint devices are used in other embodiments. Various other embodiments utilities various other types of communication connection paths that interconnect other types of endpoint devices

It is also noted that in the specific embodiments described herein, the communication paths (i.e. the communication lines) are interconnected by an IP-PBX switch. It is noted that there are a wide variety of switching devices that are commercially available to interconnect communication paths so that endpoints connected to the communication paths can communicate. The IP-PBX devices which are part of the embodiments shown and described herein are merely one example of a type of switching device that can interconnect communication paths so that endpoint devices connected to the communication paths can communicate.

It is also noted that in an alternate embodiment, instead of (or in addition to) displaying the Conference Notify softkey on a user's telephone set, the calendar program that display the conference call information, has a location or display location, that can be clicked on, to initiate the conference notification operation. Thus, the conference notification operation can be initiated by either a softkey on a telephone set or by clicking on or entering data in the calendar program display.

While the invention has been shown and described with respect to preferred embodiments thereof, it should be understood that a wide variety of other embodiments are possible without departing from the scope and sprit of the invention. The scope of the invention is only limited by the appended claims.

I claim:

1) A system comprising:
a plurality of communication paths each having an endpoint device connected thereto,
a conference bridge for connecting a plurality of said communication paths in a conference connection between the endpoint devices connected to said communication paths,
a calendar program to display the time and the participants for a scheduled conference connection between said endpoint devices,
each of said endpoint devices having a conference notify key which when activated notifies each of the endpoint devices of a scheduled conference connection that the time for the conference connection has arrived, and a conference connect key that when activated connects the endpoint device to a scheduled conference connection.

2) The system recited in claim 1 wherein said endpoint devices are Voice over Internet Protocol (VoIP) telephone sets.

3) The system recited in claim 1 including a softswitch to interconnect said communication paths.

4) The system recited in claim 1 including a presence server that communicates with said endpoint devices.

5) The system recited in claim 1 wherein said endpoint devices are Voice Over Internet Protocol (VoIP) telephone sets and said system including a presence server that communicates with said telephone sets via XML messages.

6) The system recited in claim 5 wherein said XML messages establish softkeys on said telephone sets.

7) A method comprising:
displaying information concerning a selected scheduled conference call,
activating a conference notification process that sends by instant messaging a notice to the endpoint device of each of the available scheduled participant in the displayed selected conference call, and
connecting an endpoint device to the selected conference call in response to pressing a conference connect softkey on the endpoint device of a notified participant.

8) The method of claim 7 wherein a calendar notification of conference calls is displayed on a personal computer display screen.

9) The method of claim 7 wherein a notification of a scheduled conference call is displayed on a display screen of a telephone set.

10) The method of claim 7 wherein a selected conference call is highlighted on a display screen.

11) The method of claim 7 wherein said endpoint devices are endpoint devices of a Voice over Internet protocol (VoIP) system.

12) The method of claim 11 wherein said endpoint devices are VoIP telephone sets.

13) The method of claim 12 wherein a presence server establishes a softkey on said VoIP telephone sets that can be used to activate said conference notification process.

14) The method of claim 12 wherein a presence server establishes said conference connect softkey on VoIP telephone sets.

15) A system comprising:
a plurality of communication paths each having an endpoint device connected thereto,
a switching system for interconnection said communication paths for communication between endpoint devices,
a conference call bridge connected to said switching system for connecting a plurality of said communication paths in a conference call,
a calendar display to show the time and participants for a scheduled conference call,
a presence server for determining which scheduled participants for a conference call displayed by said calendar program are available and for sending instant messages to the endpoint devices of such participants,
said endpoint devices having a conference notify key which when activated causes said presence server to send an instant message to each of the participants of a scheduled conference call indicating that the time for the conference call has arrived.

16) The system recited in claim 15 wherein said endpoint devices are Voice Over Internet Protocol (VoIP) telephone sets.

17) The system recited in claim 16 wherein said switching system is a softswitch and said endpoint devices are connected to said switching system via a wide area packet network.

18) The system recited in claim 16 wherein said calendar program displays the time and participants of a scheduled conference call on a personal computer display visible to a user of one of said telephone sets.

19) The system recited in claim 16 wherein said calendar program displays the time and participants of a scheduled conference call on a display on said telephone sets.

20) A system comprising:
means for displaying information related to the time and scheduled participants in a conference call,
means activating a conference notification process to send by instant messaging a notice to the endpoint devices of each of the available scheduled participant in a conference call displayed by said display means, and
means for connecting to the conference call when a conference connect softkey is pressed on the endpoint devices of the notified participants.

21) Logic encoded in one or more tangible media for execution and when executed operable to:
display information related to the time and scheduled participants in a conference call,
upon activation of a first softkey, sending a notification message to each of the available scheduled participants in the conference call, and
upon activation of a second softkey, connecting a notified participant to said conference call.
